(19) United States
(12) Patent Application Publication
(10) Pub. No.: US 2001/0046661 A1
(43) Pub. Date: Nov. 29, 2001

(54) Teaching apparatus

(76) Inventor: Mildred Shorter, Perris, CA (US)

Correspondence Address: Matthew J. Peirce, Esq., 1550 Starlight Canyon Avenue, Las Vegas, NV, 89123, US

(21) Appl. No.: 09/866,054

(22) Filed: May 24, 2001

Related U.S. Application Data
(60) Provisional application No. 60/206,699, filed on May 24, 2000.

(51) Int. Cl. G09B 19/00

(52) U.S. Cl. 434/395; 2/338

(57) ABSTRACT

A new and improved product designed to enhance the lives of teachers and adults in their attempts to teach handicapped individuals. The present invention will serve to greatly enhance teachers and adults who are involved in teaching handicapped individuals by assisting them in locating visual pictures during activities at home or at school. The present invention would be attached to a belt, which would be strapped around a user's waist. The present invention would also have a pair of removable felt pads, which a user would be able to attach pictures to, with the flaps being removable at the will of a user. When an adult or teacher would wish to communicate with someone, the adult or teacher would simply remove the picture and hand it to the user. The present invention would also have a front-mounted pad with an enclosed pouch which would be used for storing extra pictures and drawings, with pad including the enclosed pouch being located in front of the other two pair of flaps.

### BACKGROUND OF THE INVENTION

The present invention concerns that of a new and improved product designed to enhance the lives of teachers and adults in their attempts to teach handicapped individuals.

### DESCRIPTION OF THE PRIOR ART

U.S. Pat. No. D395,736, issued to Walters, discloses an ornamental design for an apron assembly.

U.S. Pat. No. 4,723,323, issued to Wright, Jr., discloses an activity bib worn by an adult and presented for interaction by a child facing the adult.

U.S. Pat. No. 4,710,979, issued to Bull et al., discloses a sleeveless, preferably lined, apron of jacket length sewn together at the shoulders having a back panel of about the same length as the front panel with detachable multicolored two-dimensional cut out toys on the front of the apron.

### SUMMARY OF THE INVENTION

The present invention concerns that of a new and improved product designed to enhance the lives of teachers and adults in their attempts to teach handicapped individuals. The present invention will serve to greatly enhance teachers and adults who are involved in teaching handicapped individuals by assisting them in locating visual pictures during activities at home or at school. The present invention would be attached to a belt, which would be strapped around a user's waist. The present invention would also have a pair of removable felt pads, which a user would be able to attach pictures to, with the flaps being removable at the will of a user. When an adult or teacher would wish to communicate with someone, the adult or teacher would simply remove the picture and hand it to the user. The present invention would also have a front-mounted pad with an enclosed pouch which would be used for storing extra pictures and drawings, with pad including the enclosed pouch being located in front of the other two pair of flaps.

There has thus been outlined, rather broadly, the more important features of a teaching apparatus in order that the detailed description thereof that follows may be better understood and in order that the present contribution to the art may be better appreciated. There are, of course, additional features of the teaching apparatus that will be described hereinafter and which will form the subject matter of the claims appended hereto.

In this respect, before explaining at least one embodiment of the teaching apparatus in detail, it is to be understood that the teaching apparatus is not limited in its application to the details of construction and to the arrangements of the components set forth in the following description or illustrated in the drawings. The teaching apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present teaching apparatus. It is important, therefore, that the claims be regarded as including such equivalent constructions insofar as they do not depart from the spirit and scope of the present invention.

It is therefore an object of the present invention to provide a teaching apparatus which has all of the advantages of the prior art and none of the disadvantages.

It is another object of the present invention to provide a teaching apparatus which may be easily and efficiently manufactured and marketed.

It is another object of the present invention to provide a teaching apparatus which is of durable and reliable construction.

It is yet another object of the present invention to provide a teaching apparatus which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a perspective view of the present invention.

FIG. 2 shows a rear view of a photograph that would be used with the present invention.

FIG. 3 shows a perspective view of the present invention after the front pad has been raised.

### DESCRIPTION OF THE PREFERRED EMBODIMENT

FIG. 1 shows a perspective view of the present invention. As can be seen, the present invention includes belt 2 with rear buckle 4. Belt 2 would include front-mounted felt pads 6 and 8, with front pad 10 being located in front of felt pads 6 and 8.

Felt pads 6 and 8 would be removably attached to belt 2 by attachment means 12, with attachment means 12 preferably being Velcro. Attachment means 12 would keep felt pads 6 and 8 securely attached to belt 2, but would allow felt pads 6 and 8 to be easily detached if a user so desired.

Front pad 10 would have front-mounted pouch 14 attached to it. Front pad 10 would be pivotally attached to the top of belt 2. Within pouch 14, a user would preferably store extra pictures that would be possibly used. Pouch 14 would allow a user to have at his or her disposal a large assortment of pictures which would be immediately available at any particular time. Pouch 14 would free up valuable time for a user by not requiring a user to store various assortments of pictures at other locations.

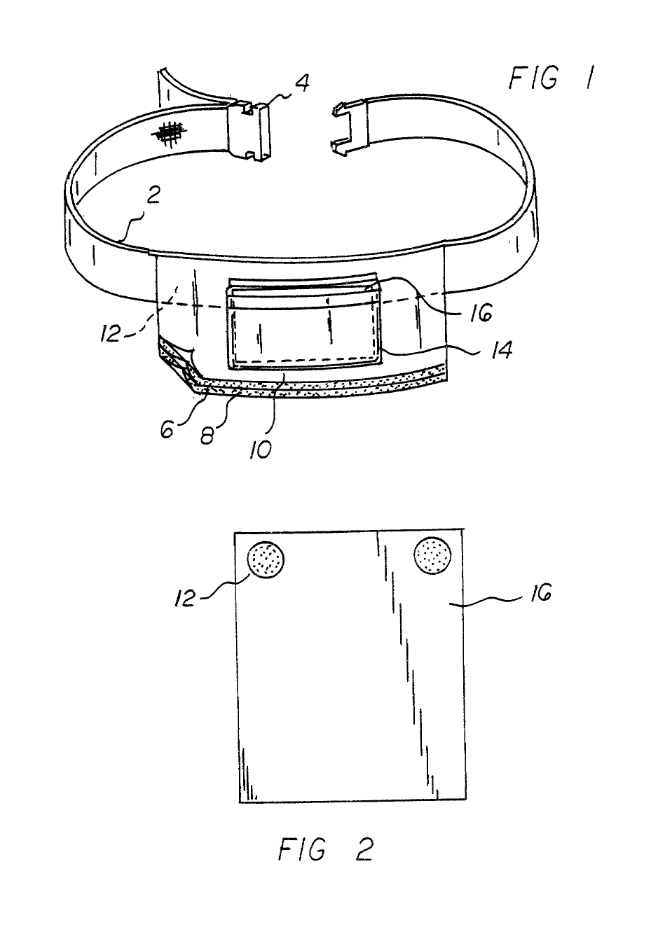

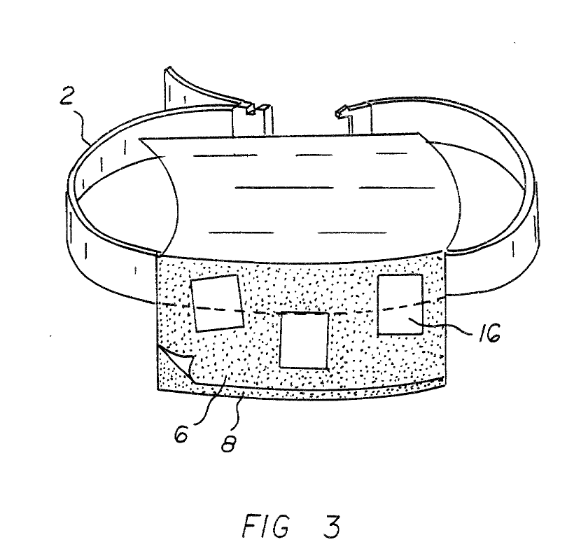

FIG. 2 shows a rear view of photograph 16 that would be used with the present invention. Attachment means 12 can be seen in the form of Velcro, which is fixedly attached to the rear face of photograph 16. The attached Velcro would firmly stick on either felt pad 6 or felt pad 8, while also allowing any particular photograph to be easily detachable.

FIG. 3 shows a perspective view of the present invention after the front pad has been raised. This drawing shows a fall front view of felt pad 6, with felt pad 8 being located immediately behind felt pad 6. Felt pad 6 and felt pad 8 are each removably attached to belt 2 by attachment means 12, which again would preferably be Velcro. By being removably attached, a user could attach various photographs 16 to a particular felt pad, detach that same felt pad, and then hand that felt pad to a user in an effort to properly communicate the message indicated by the attached photographs.

The present invention provides great benefits to adults and teachers working with children with autism and other social-communication deficits. The present invention does not require complex materials or highly technical training. It also does not require expensive equipment, comprehensive testing, costly staff, or parent training. Adults and teachers can use the present invention in a variety of settings, including the home, classroom, and community.

1. A teaching apparatus for teaching children comprising:
(a) a belt having attachment means for attaching to a person's waist, the belt having two continual surfaces, an outward-facing continual surface and an inward-facing continual surface, the belt further having two edges, a top edge and a bottom edge, the belt having two ends, a first end and a second end,
(b) a pair of felt pads, the pair comprising a first felt pad and a second felt pad, the first felt pad having two surfaces, a front surface and a rear surface, the second felt pad having two surfaces, a front surface and a rear surface, the first felt pad being removably attached to the outward-facing continual surface of the belt by an attachment mechanism, the second felt pad being removably attached to the outward-facing continual surface of the belt by an attachment mechanism, the second felt pad being removably attached to the belt immediately over the top of the first felt pad,
(c) a front pad pivotally attached to the top edge of the belt, the front pad being attached to the belt immediately above the location of the second felt pad, the front pad having a front surface and a back surface, the front pad having a small pouch attached to the front surface of the front pad, and
(d) at least one picture, the picture having a front surface and a rear surface, the picture being stored in the pouch, the picture having attachment means for attaching to the front surface of the first felt pad or the second felt pad.

2. A teaching apparatus for teaching children according to claim 1 wherein the attachment means for attaching to a person's waist comprises a belt buckle, the belt buckle comprising
(a) a first portion attached to the first end of the belt,
(b) a second portion attached to the second end of the belt,
(c) wherein the first portion is capable of removably attaching to the second portion.

3. A teaching apparatus for teaching children according to claim 2 wherein the attachment mechanism for removably attaching the first felt pad to the outward-facing continual surface of the belt comprises at least two patches fixedly attached to the rear surface of the first felt pad, each patch capable of being removably attached to the outward-facing continual surface of the belt.

4. A teaching apparatus for teaching children according to claim 2 wherein the attachment mechanism for removably attaching the second felt pad to the outward-facing continual surface of the belt comprises at least two patches fixedly attached to the rear surface of the second felt pad, each patch capable of being removably attached to the outward-facing continual surface of the belt.

5. A teaching apparatus for teaching children according to claim 2 wherein the attachment means for attaching a picture to the front surface of the first felt pad or the second felt pad comprises at least one patch fixedly attached to the rear surface of the picture, the patch capable of being removably attached to either the front surface of the first felt pad or the front surface of the second felt pad.
